(19) United States
(12) Patent Application Publication
(10) Pub. No.: US 2003/0193682 A1
(43) Pub. Date: Oct. 16, 2003

(54) Method and system for partitioning multiple media handling jobs

(76) Inventors: Travis J. Parry, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/120,593

(22) Filed: Apr. 10, 2002

(51) Int. Cl. G06F 15/00; H04N 1/04

(52) U.S. Cl. 358/1.13; 358/498

(57) ABSTRACT

This invention relates to a method and system for partitioning multiple media handling jobs in an input tray/automatic document feeder (ADF) and performing different functions for each job. Such structures of this type, generally, allow for partitioning multiple media handling jobs. For example, a user arrives at a multi-functional product (MFP) with several documents. The user wishes to fax a document, make copies of another document, and digitally transmit and archive a third document. This invention would enable the user to load all three documents into the ADF and program the MFP to perform the desired tasks on the different documents even if the documents contained differently sized and shaped media.

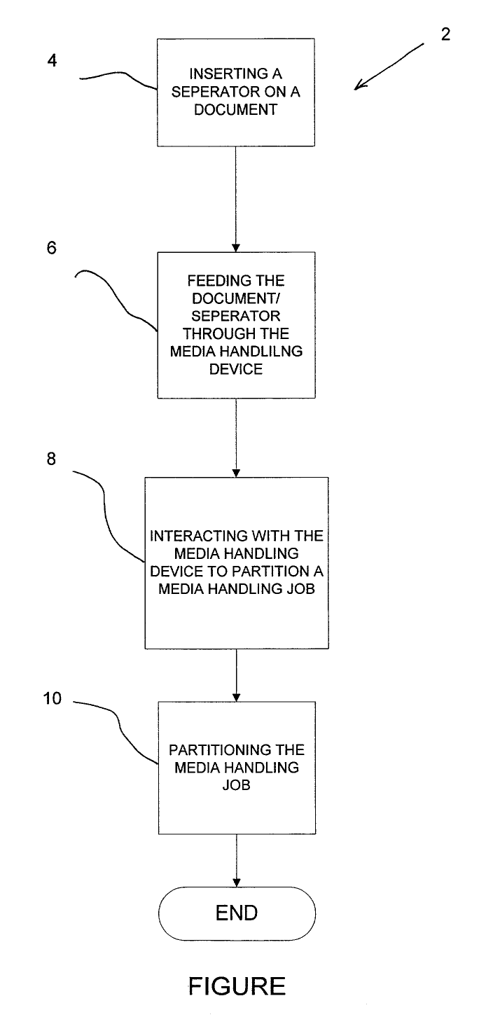

### FIELD OF THE INVENTION

This invention relates to a method and system for partitioning multiple media handling jobs in an input tray/automatic document feeder (ADF) and performing different functions for each job. Such structures of this type, generally, allow for partitioning multiple media handling jobs. For example, a user arrives at a multi-functional product (MFP) with several documents. The user wishes to fax a document, make copies of another document, and digitally transmit and archive a third document. This invention would enable the user to load all three documents into the ADF and program the MFP to perform the desired tasks on the different documents even if the documents contained differently sized and shaped media.

### DESCRIPTION OF THE RELATED ART

Many peripherals to computer networks include a scanner component. One example of such a peripheral is an “All-in-one”, also known as a multi-functional product (MFP). A MFP has the capability to perform the multiple functions of scanning hardcopy documents, copying, printing or the like. Another example is a digital network copier that scans in documents from an automatic document feeder (ADF), does high volume copying, and has the capabilities of binding, collating, folding, stacking, stapling, stitching, edge-trimming, paginating, and printing on substrates of varied composition.

Prior to the present invention, as set forth in general terms above and more specifically below, it is known, in the printing art, to utilize job partitioning. Exemplary of such prior art are U.S. Pat. No. 5,450,541 ('541) to J. L. Rourke et al., entitled “Method of Applying Electronically Stored Labels to a Print Job” and U.S. Pat. No. 5,995,721 ('721) to J. L. Rourke et al., entitled “Distributed Printing System.” The '541 and '721 references teach the use of pre-printed labels. The user can only enter an identification number on the user's computer and information related to the document to be printed. The labeled document(s) is (are) then sent to a central storage where it (they) can be later retrieved by the user. While these references disclose the use of multiple media handling job partitioning, the multiple media handling jobs are only stored. Also, the reference does not disclose the utilization of a MFP. Therefore, a more advantageous system, then, would be provided if the jobs could also be copied, faxed, sent or any combination of these and the like, the document information could be entered from a variety of sources including a multi-functional product (MFP), and the use of pre-printed labels could be eliminated.

It is apparent from the above that there exists a need in the art for a media handling job partitioning system that allows the media handling jobs to be copied, and which allows the document information to be entered from a variety of sources, but which at the same time avoids the use of pre-printed labels. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for partitioning multiple media handling jobs, wherein the method is comprised of the steps of: inserting a media handling job separator means on top of a document; feeding the document and the separator means through a media handling device; interacting with the media handling device to partition a media handling job; and partitioning the media handling job.

In certain preferred embodiments, the media handling job separator means can be, but is not limited to, plastic tabs, radio frequency identification (RFID) sensors, electronic tags, disposable separators, bar codes, wireless transmitters or the like. Also, the media handling device can be, but is not limited to, a multi-functional product (MFP) that includes one or a combination of a printer, a copier, a facsimile machine, a scanner, a printing device, a digital transmitter or the like. Finally, the media handling job can be, but is not limited to, duplexing, copying, printing, faxing, scanning, digitally transmitting, stapling, collating, scan-to-file or the like or any combination of these.

In another preferred embodiment, the invention enables a user to load multiple media handling jobs into an automatic document feeder (ADF)/input tray of a media handling device, such as a MFP, and program the media handling device to perform different functions for each job. This makes it very convenient for the user who has multiple documents to process because the user can just load the stack of documents into the ADF and come back when the various media handling jobs are complete.

The preferred partitioning method, according to this invention, offers the following advantages: ability to partition multiple media handling jobs; ability to utilize a variety of media handling devices; ability to complete a variety of media handling jobs; and excellent economy. In fact, in many of the preferred embodiments, these factors of ability to partition multiple media handling jobs, ability to utilize a variety of media handling devices, ability to complete a variety of media handling jobs, and excellent economy are optimized to an extent that is considerably higher than heretofore achieved in prior, known partitioning methods.

The above and other features of the present invention, which will become more apparent as the description proceeds, are best understood by considering the following detailed description in conjunction with the accompanying drawing FIGURE and in which:

### BRIEF DESCRIPTION OF THE DRAWING

The FIGURE is a flowchart that illustrates a method for partitioning multiple media handling jobs, according to one embodiment of the present invention.

### DETAILED DESCRIPTION OF THE INVENTION

With reference first to the FIGURE, there is illustrated one preferred embodiment for use of the concepts of this invention. Method 2 for partitioning multiple media handling jobs is illustrated in the FIGURE. Method 2 includes, in part, the steps of: inserting a separator on a document that is to undergo a media handling job (step 4); feeding the document and the separator through the media handling device (step 6); interacting with a media handling device to partition a media handling job (step 8); and partitioning the media handling job (step 10).

With reference to step 4, the separator can be, but is not limited to, a plastic tab, a radio frequency identification (RFID) sensor, an electronic tag, a disposable separator, a bar code, a wireless transmitter or the like. Also, the media handling job can be, but is not limited to, duplexing, copying, printing, faxing, scanning, digitally transmitting, stapling, collating, store-to-file or the like.

With respect to step 6, the media handling device can be, but is not limited to, a multi-functional product (MFP) that includes one or a combination of a printer, a copier, a facsimile machine, a scanner, a printing device, a digital transmitter or the like.

With reference to step 8, the user interacts with the media handling device by operating various keys/functions of a graphical user interface (GUI) (not shown) located on the media handling device. Optionally, the separator could contain the information as to the various functions to perform via a bar code, a radio frequency identification (RFID) tag or the like.

During the operation of method 2, the following example will be assumed. The user has two documents and desires to have one document copied and the other faxed to a desired recipient. The user can place a separator, such as, a disposable separator on top of the documents to be copied and faxed (step 4). The user then puts the documents/separators into the automatic document feeder (ADF)/input tray of the media handling device that the user wants to perform the various media handling jobs (step 6).

The media handling device senses the separators and responds back to the user through the GUI located on the media handling device. For example, the GUI may ask the user what media handling jobs the user wants the media handling device to complete. The user then informs the media handling device that the user, in this instance, wants the media handling device to make a copy of a document and fax a copy of the other document to a desired recipient.

The media handling device would then request information through the GUI regarding the number of copies to be made, the media size to be utilized during the copying process, and any other relevant requests regarding the copying process and the telephone number or other such contact information of the desired recipient's facsimile machine. The user would enter the requested copying information and the contact information. Finally, after the media handling device is satisfied that all the relevant information has been entered by the user, the media handling device will then partition the media handling jobs according to the desires of the user by copying the one document and faxing the other document.

It is to be understood that while a disposable separator is described, many other suitable such separators can be used as long as they provide information to the media handling device that different media handling jobs are required and allow the media handling device to request information from the user regarding the different media handling jobs. Also, pre-formatted separators could be used to place upon documents that are sent to a regular/common recipient. Also, multiple separators could be placed upon the document in case the user wants the media handling device to complete a variety of media handling jobs of the document, as discussed above. Finally, separators could be stored on the hard drive of the media handling device. In this manner, the user would merely have to print off a copy of the separator, place it upon the document, and proceed, as discussed above.

It is also to be understood that method 2 can partition the media handling jobs of differently sized and shaped media. Also, before starting the partitioning process, the media handling device senses how many partitioning jobs there are by the number of separators used or any combination of different types of separators used. The media handling device then prompts the user to enter the appropriate information regarding the media handling jobs to be completed, such as fax number, recipient e-mail or the like for each job. However, it is to be understood that a pre-configured script could be transmitted by the user that would instruct the media handling device of the different operations to perform for each media handling job.

Finally, it is to be understood that separator “paddles” or hardware separators could be used to provide separation between multiple media handling jobs. For example, a separator arm (not shown) in the ADF could be used that comes down to mark the last page of the document to be handled by the media handling device when the ADF counts the pages of the document before the media handling device processes the media handling job. The paddles/separators could be conventionally activated either automatically or manually. In this manner, the user merely loads the first document into the ADF, presses the media handling job separator button (not shown), the separator comes into contact with the last page of the document, the user loads the next document into the ADF, the user presses the media handling job separator button, the separator comes into contact with the last page of the second document and so forth until all the documents to be handled have been loaded into the ADF. Once all the documents have been loaded, the user merely enters the media handling job parameters for the various documents into the media handling device and presses the start button on the media handling device to execute the multiple tasks on the multiple handling jobs.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for partitioning multiple media handling jobs, comprising the steps of:
inserting a media handling job separator means on top of a document;
feeding said document and said separator means through a media handling device;
interacting with said media handling device to partition a media handling job; and
partitioning said media handling job.

2. The method, as in claim 1, wherein said separator means is further comprised of:
a disposable separator.

3. The method, as in claim 1, wherein said separator means is further comprised of:
a RFID sensor.

4. The method, as in claim 1, wherein said separator means is further comprised of:
a bar code.

5. The method, as in claim 1, wherein said separator means is further comprised of:
a wireless transmitter.

6. The method, as in claim 1, wherein said feeding step is further comprised of the step of:
feeding said document and said separator means through an automatic document feeder located on said media handling device.

7. The method, as in claim 1, wherein said feeding step is further comprised of the step of:
feeding said document and said separator means through an input tray located on said media handling device.

8. The method, as in claim 1, wherein said interacting step is further comprised of the steps of:
sensing of said separator means by said media handling device;
requesting, by said media handling device, further information regarding said partitioning of said media handling job; and
inputting, by a user, said requested further information.

9. The method, as in claim 1, wherein said separator means is further comprised of:
a plurality of separator means.

10. The method, as in claim 1, wherein said media handling device is further comprised of:
a multi-functional product.

11. A program storage medium readable by a computer, tangibly embodying a program of instructions executable by said computer to perform the method steps for partitioning multiple media handling jobs, comprising the steps of:
inserting a media handling job separator means on top of a document;
feeding the document and the separator means through a media handling device;
interacting with the media handling device to partition a media handling job; and
partitioning the media handling job.

12. The method, as in claim 11, wherein said separator means is further comprised of:
a disposable separator.

13. The method, as in claim 11, wherein said separator means is further comprised of:
a RFID sensor.

14. The method, as in claim 11, wherein said separator means is further comprised of:
a bar code.

15. The method, as in claim 11, wherein said separator means is further comprised of:
a wireless transmitter.

16. The method, as in claim 11, wherein said feeding step is further comprised of the step of:
feeding said document and said separator means through an automatic document feeder located on said media handling device.

17. The method, as in claim 11, wherein said feeding step is further comprised of the step of:
feeding said document and said separator means through an input tray located on said media handling device.

18. The method, as in claim 11, wherein said interacting step is further comprised of the steps of:
sensing of said separator means by said media handling device;
requesting, by said media handling device, further information regarding said partitioning of said media handling job; and
inputting, by a user, said requested further information.

19. The method, as in claim 11, wherein said separator means is further comprised of:
a plurality of separator means.

20. The method, as in claim 11, wherein said media handling device is further comprised of:
a multi-functional product.
